(19) United States
(12) Patent Application Publication
(10) Pub. No.: US 2019/0112186 A1
(43) Pub. Date: Apr. 18, 2019

(54) HIERARCHICAL MICROSTRUCTURE, MOLD FOR MANUFACTURING SAME, AND METHOD FOR MANUFACTURING SAME MOLD

(71) Applicants: Global Frontier Center for Multiscale Energy, Seoul (KR); Seoul National University R&DB Foundation, Seoul (KR)

(72) Inventors: Segeun Jang, Gyeonggi-do (KR); Man Soo Choi, Seoul (KR); Sang Moon Kim, Gyeonggi-do (KR)

(21) Appl. No.: 16/090,314

(22) PCT Filed: Apr. 7, 2017
(86) PCT No.: PCT/KR2017/003796

§ 371 Date: Oct. 1, 2018

(30) Foreign Application Priority Data
Apr. 8, 2016 (KR) 10-2016-0043149

(51) Int. Cl. B82B 3/00

(52) U.S. Cl. CPC B82B 3/0014; B82Y 40/00

(57) ABSTRACT

The present invention provides a hierarchical microstructure having nanopatterns formed on an upper surface as well as a side surface thereof, so as to maximize the effect of a multiscale structure. Therefore, the hierarchical microstructure can have a wider surface area. Also, the present invention provides a method of preparing a mold for forming the hierarchical microstructure using a sequential imprinting procedure and a creep behavior. According to the present invention, the mold for forming a hierarchical microstructure can be prepared more effectively and easily.

### TECHNICAL FIELD

The present invention relates to a method of manufacturing a hierarchical microstructure and a mold for forming the microstructure by way of sequential imprinting, more particularly a method of preparing a hierarchical microstructure having a wider specific surface area.

### BACKGROUND ART

Since the 1980's, most of industrial parts have been made smaller. In accordance with this tendency, it is increasingly necessary to form micro or nano-sized structures (hereinafter referred to as ‘microstructures’). In response to these demands, various techniques for forming reliable microstructures economically and easily have been proposed.

Typically, the microstructures have been known to be formed by a nanoimprint lithography technique, which can produce a small structure having a size of several tens of nanometers by using a mold having a high strength.

In particular, a combined multiscale hierarchical structure of micro and nano-sized repeating patterns has attracted attention due to its structural advantages that both micro and nano shapes are provided.

The synergistic effect of the multiscale structures can provide multifunctional properties to raw materials without any chemical treatment including optical, wetting and adhesion, and also the value thereof has been confirmed in various applications such as microfluidics, electronic devices, optical and energy systems.

Recent studies have found that the soles of gecko lizards and lotus leaves found in nature have a surface of double roughness structure, which provides excellent adhesion on super-hydrophobic surfaces and curved objects.

However, the known pattern fabrication methods have a problem that it is difficult to perform uniform patterning in wide areas, and it needs a long process. Therefore, many researchers have studied a variety of processes to produce multiscale structures covering wide areas.

### DETAILED DESCRIPTION OF THE INVENTION

### Technical Problem

The present invention is designed to solve the problem of the related art, and thus, it is an aspect of the present invention to provide a hierarchical microstructure which comprises a combination of nanopatterns and micropatterns to have wider specific surface area.

It is other aspect of the present invention to provide a mold for forming the hierarchical microstructure

It is another aspect of the present invention to provide a method of preparing of the mold for forming the hierarchical microstructure.

It is still another aspect of the present invention to provide a membrane electrode assembly (MEA) prepared by using the hierarchical microstructure.

### Technical Solution

In order to accomplish the above aspect, the present provides a hierarchical microstructure comprising one or more layers having nanopatterns and micropatterns formed therein, wherein the nanopatterns are formed on an upper surface and a side surface of the micropatterned layer.

Also, the present invention provides a mold for forming the hierarchical microstructure, which has engraved patterns corresponding to 3-dimensional fine patterns including the nanopatterns and micropatterns formed in the hierarchical microstructure.

In addition, the present invention provides a method of preparing the mold for forming a hierarchical microstructure and a mold prepared therefrom, the method comprising:

forming a polymer membrane on a substrate;

aligning a nanopatterned first mold on the polymer membrane, followed by heating and compressing at a first temperature and a first pressure and then cooling, so that nanopatterns corresponding to the nanopatterns of the first mold are formed on the polymer membrane; and

aligning a micropatterned second mold on the nanopatterned polymer membrane, followed by heating and compressing at a second temperature and a second pressure and then cooling, so that micropatterns corresponding to the micropatterns of the second mold are formed on the nanopatterned polymer membrane.

The method of preparing the mold further comprises thinly coating a polymer having a low creep behavior to produce a sacrificial layer for reserving the original shape of the nanopatterns after forming the nanopatterns using the first mold, and removing the sacrificial layer using a solvent after forming the micropatterns using the second mold.

The polymer may be polymethyl methacrylate (PMMA) or polystyrene (PS), and the solvent may be a nonpolar solvent such as toluene.

Further, the present invention provides a method of preparing a hierarchical microstructure and a hierarchical microstructure prepared therefrom, the method comprising:

applying a photocurable pre-polymer composition on a mold for forming a hierarchical microstructure;

curing the applied photocurable pre-polymer composition; and

detaching the cured polymer product the polymer membrane.

Furthermore, the present provides a membrane electrode assembly prepared by using the hierarchical microstructure.

### Advantageous Effects

The hierarchical microstructure according to the present invention is nanopatterned on an upper surface as well as a side surface thereof, so as to maximize the effect of a multiscale structure. Therefore, the hierarchical microstructure can have a wider surface area. Also, the present invention can prepare a mold for forming a hierarchical microstructure more effectively and easily by using a sequential imprinting procedure and a creep behavior in the preparation thereof.

### BRIEF DESCRIPTION OF THE DRAWINGS

FIG. 1 schematically shows procedures of preparing a hierarchical microstructure by way of sequential imprinting.

FIG. 2 shows an SEM image for the hierarchical microstructure in accordance with one embodiment of the present invention.

FIG. 3 shows an SEM image for the cross-section of MEA prepared by using the hierarchical microstructure of the present invention.

FIG. 4 shows an SEM image for the surfaces of multiscale polymer membrane according to heating temperature in imprinting using a creep behavior.

FIG. 5 schematically shows procedures of preparing a mold by way of sequential imprinting in accordance with other embodiment of the present invention.

FIG. 6 shows an SEM image for the mold prepared in accordance with the embodiment of FIG. 5.

### BEST MODE

Hereinafter, the drill device according to one embodiment of the present invention will be described in detail with reference to the accompanying drawings which illustrate a preferable example of the present invention for the purpose of better explanation, not intended to limit the technical scope of the invention.

The hierarchical microstructure according to the present invention comprises one or more layers having nanopatterns and micropatterns formed therein, wherein the nanopatterns are formed on an upper surface and a side surface of the micropatterned layer.

In one embodiment of the present invention, the side surface of the hierarchical microstructure forms an inclined plane making an angle of 1° to 45° with an axis perpendicular to the upper surface of the micropatterned layer.

The present invention provides a mold for forming the hierarchical microstructure, the mold having engraved patterns corresponding to 3-dimensional fine patterns including the nanopatterns and micropatterns formed in the hierarchical microstructure.

Also, the present invention provides a method of preparing the mold for forming the hierarchical microstructure, the mold-preparing method comprises:

forming a polymer membrane on a substrate;

aligning a nanopatterned first mold on the polymer membrane, followed by heating and compressing at a first temperature and a first pressure and then cooling, so that nanopatterns corresponding to the nanopatterns of the first mold are formed on the polymer membrane; and

aligning a micropatterned second mold on the nanopatterned polymer membrane, followed by heating and compressing at a second temperature and a second pressure and then cooling, so that micropatterns corresponding to the micropatterns of the second mold are formed on the nanopatterned polymer membrane,

wherein the second pressure is higher than the first pressure and the second temperature is lower than the first temperature.

The mold-preparing method further comprises thinly coating a polymer having a low creep behavior to produce a sacrificial layer for reserving the original shape of the nanopatterns after forming the nanopatterns using the first mold, and removing the sacrificial layer using a solvent after forming the micropatterns using the second mold.

The polymer may be polymethyl methacrylate (PMMA) or polystyrene (PS), and the solvent may be a nonpolar solvent such as toluene.

In the present invention, the mold for the hierarchical microstructure may be a polymer membrane which has an engraved multiscale structure including the nanopatterns and micropatterns.

In accordance with one embodiment, the first heating temperature may be above the glass transition temperature (Tg) of the polymer membrane and the second heating may be below the Tg of the polymer membrane.

In the mold-preparing method, the formation of micropatterns using the second mold on the nanopatterned polymer membrane may be carried out using a creep behavior without damage of the nanopatterns, which can give a hierarchical microstructure having the nanopatterns on the side surface thereof.

As used herein, the term ‘creep behavior’ refers to the tendency of a solid material to move slowly and deform permanently depending on time under the influence of deformation force. For example, the imprinting method, which is general to form a patterned polymer membrane, is carried out by heating at a temperature above the Tg of the polymer membrane using a patterned mold, thereby forming patterns on the polymer membrane. In contrast, the patterning method by the creep behavior is carried out by applying mechanical stresses for a long time under a temperature below the polymer membrane and a constant pressure using a patterned mold, thereby forming patterns on the polymer membrane.

In accordance with one embodiment, the first heating temperature may be above the glass transition temperature (Tg), preferably ranging from Tg−30° C. to Tg+20° C. If the first heating temperature exceeds such range, it may increase a cooling time after transferring the patterns, thereby causing the deformation of the patterns and eventually failing to obtain the sufficient effects of nanopatterning.

The second heating temperature may be below the glass transition temperature (Tg), preferably ranging from Tg−70° C. to Tg−40° C., more preferably ranging from Tg-60° C. to Tg−40° C. As the second heating temperature approaches the Tg, the nanopatterns formed on the polymer membrane may be deformed or removed. If the imprinting procedure using a creep behavior is carried out at a too low temperature, it may need excessive pressure or take a longer time of applying pressure, thereby reducing the efficiency of the process. For example, the second heating temperature may ranges from 70° C. to 100° C.

In accordance with one embodiment, the first pressure may be 3 MPa or less, preferably 1 MPa or less and at least 0.1 MPa or more. The second pressure may be higher than the first pressure and may be applied by mechanic stresses for a long time. For example, the second pressure may be 10 MPa or less, preferably 5 MPa or less, more preferably 3 MPa or less and at least 1 MPa or more.

In accordance with one embodiment, the heating and compressing at the first heating temperature and the first pressure may be carried out for 10 minutes or less, preferably 5 minutes or less and at least 30 seconds or more. The heating and compressing at the second heating temperature and the second pressure may be carried out at a pressure higher than the first pressure for a longer time, for example 60 minutes or less, preferably 40 minutes or less and at least 10 minutes or more.

In the micropatterning process using the creep behavior according to one embodiment, the micropatterned part of the polymer membrane, which is heated and compressed by the second mold at the second temperature and the second pressure, may be partially restored in its shape by the resilience of the polymer membrane after the pressure of the second mold is removed. That is, the polymer membrane being taken the micropattern-shape by pressure may partially restored by the resilience to return to the original shape during removing the pressure of the mold. From this, a side surface of the micropatterns may be slightly inclined. For example, the side surface of the micropatterns may be inclined at an angle of 1° to 45°, preferably 1° to 30°, with respect to an axis perpendicular to the upper surface of the micropatterns.

After such heating and compressing, the procedure of cooling may be carried out at room temperature, for example 20° C. to 25° C.

The polymer membrane to be nanopatterned and micropatterned may be any polymer that can deformed by heating and compressing, for example hydrocarbon-based polymers, such as polyamide, polyacetal, polyethylene, polypropylene, acrylic resin, polyester, polysulfone, polyether and derivatives thereof, polystyrene, polyamide having aromatic rings, polyamideimide, polyimide, polyester, polyetherimide, polyether sulfone, polycarbonate and derivatives thereof, polyether ether ketone, polyether ketone, polyether sulfone, polyphenylene sulfide and derivatives thereof, polystyrene-graft-ethylene tetrafluoroethylene copolymer that a sulfonic acid group is introduced, polystyrene-graft-polytetrafluoroethylene and derivatives thereof, a Nation™ membrane (manufactured by DuPont) that is a perfluoropolmer having a sulfonic acid group in the side chain thereof, Aciplex™ membrane (manufactured by Asahi Kasei) and a Flemion™ membrane (manufactured by Asahi Glass). Also, inorganic polymer compounds organic silicon polymers may be used, and preferable examples thereof includes siloxane-based or silane-based, particularly alkylsiloxane-based compound, specifically polydimethylsiloxane and γ-glycidoxypropyltrimethoxysilane, but are not limited thereto.

In accordance with the present invention, the first mold and the second mold may be prepared by conventional photolithography methods, specifically comprising:

applying a curable pre-polymer composition on a nano- or micro-patterned silicon mater;

curing the applied curable pre-polymer composition; and

detaching the cured polymer from the silicon mater.

The nanopatterns may have a diameter of 50 to 900 nm, preferably 400 to 900 nm. Also, the micropatterns may have a diameter of 10 to 500 μm, preferably 20 to 100 μm.

In accordance with one embodiment, the first mold and the second mold may also be a photocurable polymer, or a polymer that does not undergo deformation under heating conditions or has glass transition temperature than that of the polymer membrane. For example, polymers such as polymer stamp materials which may comprise at least one selected from polyurethane acrylate (PUA), polydimethylsiloxane (PDMS), ethylene tetrafluoroethylene (ETFE), perfluoroalkyl acrylate (PFA), perfluoropolyether (PFPE) and polytetrafluoroethylene (PTFE), or inorganics such as silicon oxide (SiO₂) may be used alone or in combination of two or more thereof. Preferably, at least one selected from the group comprising polydimethylsiloxane (PDMS) and polyurethane acrylate (PUA) may be used.

The photocurable polymer may be used together with a photoinitiator. For example, the photoinitiator may be used an amount of 10 parts by weight based on 100 parts by weight of a UV curable resin. Examples of the photoinitiator may include hydroxy acetophenones such as chloroacetophenone, diethoxy acetophenone, 1-phenyl-2-hydroxy-2-methyl propane-1-one, 1-hydroxy cyclohexyl phenyl ketone (HCPK), α-amino acetophenone, benzoin ether, benzyl dimethyl ketal, benzophenone, thioxanthone, 2-ethyl anthraquinone (2-ETAQ), and 2,2-dimethyoxy-1,2-diphenylethan-1-one), but are not limited thereto. Also, the resin may be used together with a reactive diluent such as N-vinyl-2-pyrrolidone and aliphatic glycidyl ethers containing a C₁₂-C₁₄ alkyl chain. These components may be selectively used in the form of a mixture, considering curing time, reactive conditions such as wavelengths of rays, and properties such as viscosity and hardness. Also, The mixing ratio of these components may be controlled.

In accordance with one embodiment, the first mold and the second mold may be subject to pre-treatment in their surface to facilitate the detachment of them from the polymer. Specifically, the pre-treatment may be carried out by way of reactive ion etching (RIE).

The RIE procedure may be carried out by dry etching methods, for example capacitive coupled plasma (CCP), helicon wave, inductive coupled plasma (ICP) or electron cyclotron resonance (ECR). The dry etching methods use gases, for example gases containing a halogen atom such as F, Cl, Br, and a mixture thereof. Specifically, CF₄, CHF₃, C₂F₆, C₃F₈, C₄F₈, SF₆, Cl₂, BCl₃, HCl, HBr, and I₂ may be selectively used depending on the components of a material. In addition, a gas such as O₂, N₂, H₂, Ar and He may be added for the control of etching shapes.

In accordance with one embodiment, the curable pre-polymer may be a photocurable polymer. The curing of the pre-polymer may be carried out by applying it on the silicon master, followed by exposure to a UV ray for 10 seconds to 1 minute, for example 30 seconds.

In accordance with one embodiment, after applying the curable pre-polymer on the silicon master, a polymer film or a substrate as a support may also be displaced on the curable pre-polymer composition, from which a pattered membrane having the polymer film or substrate as a back bone may be formed after curing. The polymer film or substrate may be used without a limit if it can satisfy the properties that penetrates a UV ray, does not undergo deformation during photocuring and has good adhesion with a polymer. Also, the curable polymer may be coated on the support polymer in a certain thickness, for example 100 to 300 μm. The support polymer may be a film or substrate comprising silicon, glass, polymethyl methacrylate (PMMA), polyvinyl pyrrolidone (PVP), polystyrene (PS), polycarbonate (PC), polyethersulfone (PES), cyclic olefin copolymer (COC), triacetylcellulose (TAC), polyvinyl alcohol, polyimide (PI), polyethylene terephthalate (PET) and polyethylene naphthalate (PEN).

The present invention provides a method of preparing a hierarchical microstructure having nanopatterns and micropatterns therein using a mold prepared by the above-mentioned method.

The hierarchical microstructure-preparing method using the mold comprises:

applying a photocurable pre-polymer composition on the mold for forming a hierarchical microstructure;

curing the applied photocurable pre-polymer composition; and detaching the cured polymer product the polymer membrane.

The photocurable pre-polymer composition applied on the mold may comprise a polymer such as polymer stamp materials which may comprise at least one selected from polyurethane acrylate (PUA), polydimethylsiloxane (PDMS), ethylene tetrafluoroethylene (ETFE), perfluoroalkyl acrylate (PFA), perfluoropolyether (PFPE) and polytetrafluoroethylene (PTFE), or inorganics such as silicon oxide (SiO₂). These may be used alone or in combination of two or more thereof. Preferably, at least one selected from the group comprising polydimethylsiloxane (PDMS) and polyurethane acrylate (PUA) may be used.

In accordance with one embodiment, after applying the curable pre-polymer on the silicon master, a polymer film or a substrate as a support may also be displaced on the curable pre-polymer composition, from which a pattered membrane having the polymer film or substrate as a back bone may be formed after curing. The polymer film or substrate may be used without a limit if it can satisfy the properties that penetrates a UV ray, does not undergo deformation during photocuring and has good adhesion with a polymer. Also, the curable polymer may be coated on the support polymer in a certain thickness, for example 100 to 300 μm. The support polymer may be a film or substrate comprising silicon, glass, polymethyl methacrylate (PMMA), polyvinyl pyrrolidone (PVP), polystyrene (PS), polycarbonate (PC), polyethersulfone (PES), cyclic olefin copolymer (COC), triacetylcellulose (TAC), polyvinyl alcohol, polyimide (PI), polyethylene terephthalate (PET) and polyethylene naphthalate (PEN).

Then, the photocuring and detachment procedures of the pre-polymer are the same as the first mold and the second mold.

Thus, the present invention can prepare the hierarchical microstructure more easily. The hierarchical microstructure has multiscale structure comprising nanopatterns on the side surface thereof to provide a wider specific surface area, which can be effectively used in various field including natural inspired technology, optical devices, electric and electronic devices and microfluidic devices.

For example, the use of the hierarchical microstructure as a mold can provide a polymer membrane which has a multiscale structure having engraved patterns corresponding to the nanopatterns and micropatterns of the hierarchical microstructure, and the multiscale structured polymer membrane can be effectively used in the preparation of a membrane electrode assembly (MEA) of a fuel cell that needs a wider specific surface area.

Hereinafter, the present invention will be described in more detail with reference to Examples. It will be apparent to those skilled in the art that the following examples are intended to be illustrative of the present invention and not to be construed as limiting the scope of the invention.

### Preparation Example 1: Preparation of Nanopatterned First Mold

On a silicon master having arrays of a 800 nm-diameter sized nanohole patterns, a UV curable polyurethane acrylate (PUA)-containing pre-polymer solution (PUA MINS 301 RM, Minuta Tech, Korea) was dropped, and then a polyethylene terephthalate (PET) film having a 250 μm-thickness of urethane coatings was displaced as a support layer. After the pre-polymer was exposed to a UV ray (Fusion Cure System, Minuta Tech, Korea) for about 30 seconds, the cured PUA polymer was detached from the silicon master to prepare a first mold that is a hard polymer mold for forming nanopatterns.

The first mold was subject to pre-treatment by way of reactive ion etching (RIE) using an octafluorocyclobutane (C₄F₈) gas.

### Preparation Example 2: Preparation of Micropatterned First Mold

On a silicon master having arrays of a 40 μm-diameter sized microhole patterns, a UV curable polyurethane acrylate (PUA)-containing pre-polymer solution (PUA MINS 301 RM, Minuta Tech, Korea) was dropped, and then a polyethylene terephthalate (PET) film having a 250 μm-thickness of urethane coatings was displaced as a support layer. After the pre-polymer was exposed to a UV ray (Fusion Cure System, Minuta Tech, Korea) for about 30 seconds, the cured PUA polymer was detached from the silicon master to prepare a second mold that is a hard polymer mold for forming micropatterns.

The second mold was subject to pre-treatment by way of reactive ion etching (RIE) using an octafluorocyclobutane (C₄F₈) gas.

### Example 1: Preparation of Mold for Forming Hierarchical Microstructure

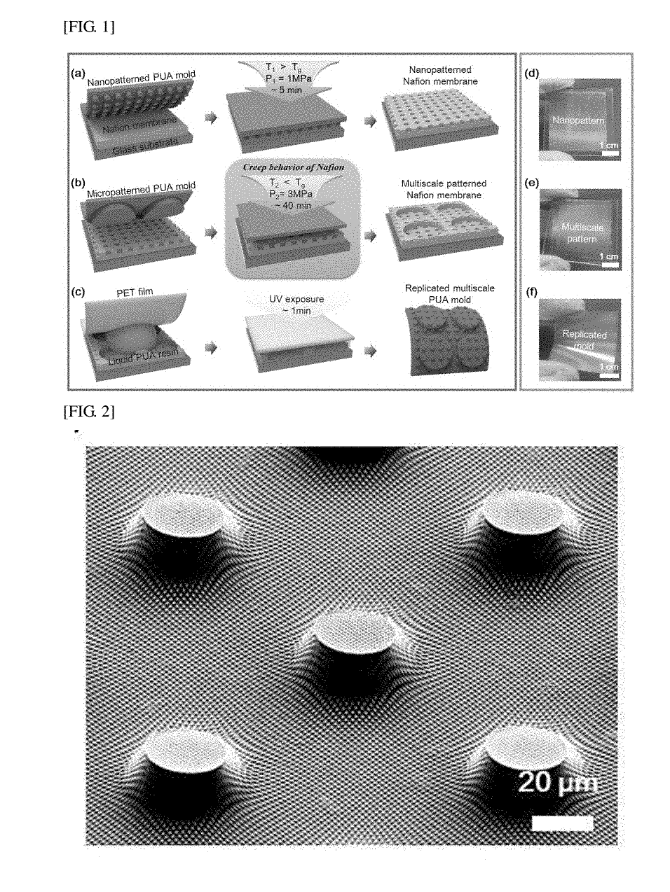

Nafion 212 membrane (Dupont, Wilmington, Del., United States) was interposed between the nanopatterned first mold prepared in Preparation Example 1 and a glass substrate to provide an assembly. Then, the assembly was heated and compressed at a flow pressure of 1 MPa and a temperature of 120° C. or less for 5 minutes. After cooling the assembly to room temperature, the first mold was removed (FIG. 1a). FIG. 1d shows the nanopatterned Nafion membrane prepared by the above method. The nanopatterned Nafion membrane exhibits to be rainbow-colored by the nanopatterns.

The nanopatterned Nafion membrane was again interposed between the micropatterned second mold and a glass substrate, followed by imprinting using a creep behavior at a temperature below 80° C., the Tg of the Nafion, and a flow pressure of 3 MPa for 40 minutes. After the creep procedure, the resultant assembly was detached from the second mold to prepare the multiscale patterned Nafion membrane (FIG. 1b). FIG. 1e shows the multiscale patterned Nafion membrane after the formation of micropatterns. The multiscale patterned membrane exhibits to have relatively opaque white areas.

On the multiscale patterned membrane, a UV curable polyurethane acrylate (PUA)-containing pre-polymer solution (PUA MINS 301 RM, Minuta Tech, Korea) was dropped, and then a polyethylene terephthalate (PET) film having a 250 μm-thickness of urethane coatings was displaced as a support layer. After the pre-polymer was exposed to a UV ray (Fusion Cure System, Minuta Tech, Korea) for about 30 seconds, the cured PUA polymer was detached from the Nafion membrane to prepare a hierarchical microstructure (FIG. 1c). FIG. 1f shows the hierarchical microstructure film being replicated by the multiscale patterns of the Nafion membrane, the film exhibiting a color similar to the multiscalepatterned membrane.

FIG. 2 shows an SEM image for the hierarchical microstructure prepared in the above.

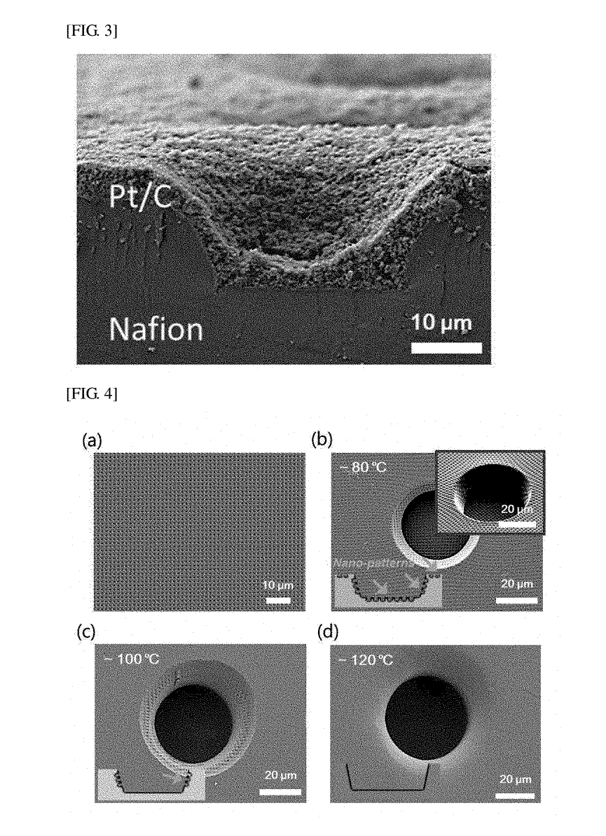

The hierarchical microstructure can be used as a mold for forming a membrane electrode assembly (MEA) for a fuel cell. For example, the patterns of the hierarchical microstructure is replicated on the Nafion membrane to prepare a multiscale patterned Nafion membrane, and a catalyst layer is formed thereon, which can be used as the MEA. FIG. 3 shows an SEM image for the cross-section of MEA as prepared in the above. Upon removing the pressure of the second mold during imprinting using a creep behavior, the resilience of the Nafion membrane was recovered and the deformed Nafion membrane was restored, from which the side surface of the multiscale structure exhibited a shape being slightly inclined, not completely perpendicular.

### Experimental Example: Change of Nanopatterns Depending on Heating Temperature of Micropatterning

### Example 2

Nafion 212 membrane (Dupont, Wilmington, Del., United States) was interposed between the nanopatterned first mold prepared in Preparation Example 1 and a glass substrate to provide an assembly. Then, the assembly was heated and compressed at a flow pressure of 1 MPa and a temperature of 120° C. or less for 5 minutes. After cooling the assembly to room temperature, the first mold was removed. FIG. 4a shows an SEM image for the nanopatterned Nafion membrane.

The nanopatterned Nafion membrane was again interposed between the micropatterned second mold and a glass substrate, followed by imprinting using a creep behavior at a temperature below 80° C., the Tg of the Nafion, and a flow pressure of 3 MPa for 40 minutes. After the creep procedure, the resultant assembly was detached from the second mold to prepare the multiscale patterned Nafion membrane. FIG. 4b shows the multiscale patterned Nafion membrane obtained in the above.

### Comparative Example 1

The procedures of Example 2 were repeated excepting that the micropatterning using the second mold was carried out at a heating temperature of 100° C. FIG. 4c shows the Nafion membrane obtained in the above.

### Comparative Example 2

The procedures of Example 2 were repeated excepting that the micropatterning using the second mold was carried out at a heating temperature of 120° C. FIG. 4d shows the Nafion membrane obtained in the above.

As shown in FIGS. 4b to 4d, the nanopatterns exhibited to be crushed and removed at a temperature near the Tg. Accordingly, in order to form the hierarchical microstructure according to the present invention, the imprinting procedure using a creep behavior may be carried out at a temperature lower than a Tg, for example 100° C. or less, which is a temperature lower by 40° C. or more than the Tg, 140° C. of the Nafion.

### Example 3

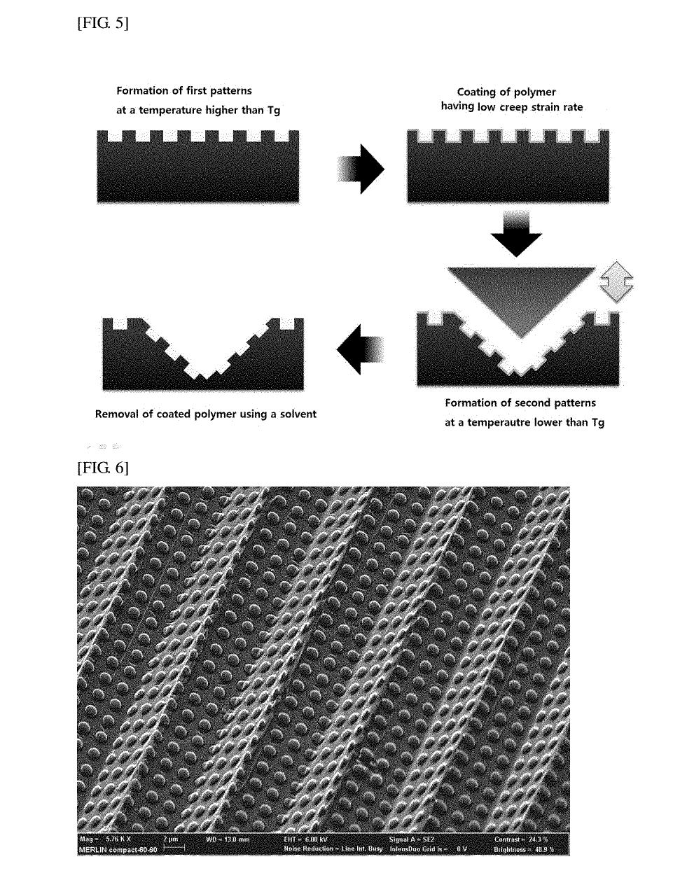

As shown in FIG. 5, nanopatterning was first carried out using a first mold. Thereon, a solution of PMMA dissolved in toluene, which has a low creep strain rate, was coated so that the dried coating thickness becomes about 1 μm, thereby forming a sacrificial layer. Then, micropatterning was carried out using a second mold. Finally, the sacrificial layer was removed using toluene.

FIG. 6 shows an SEM image for the mold prepared. From FIG. 6, it was confirmed that nanopatterns (first patterns) were well maintained by virtue of the sacrificial layer having a low creep strain rate, and micropatterns (second patterns) were clearly carved by creep strain.

While the present invention has been particularly shown and described with reference to figures and embodiments thereof, it will be understood by those of ordinary skill in the art that the scope of the present invention is not limited thereby and that various changes and modifications may be made therein. Therefore, the actual scope of the present invention will be defined by the appended claims and their equivalents.

1. A hierarchical microstructure comprising one or more layers having nanopatterns and micropatterns formed therein, wherein the nanopatterns are formed on an upper surface and a side surface of the micropatterned layer.

2. The hierarchical microstructure according to claim 1, wherein the side surface is inclined at an angle of 1° to 45° with respect to an axis perpendicular to the upper surface of the micropatterned layer.

3. A mold for forming the hierarchical microstructure according to claim 1, having engraved patterns corresponding to 3-dimensional fine patterns including the nanopatterns and micropatterns formed in the hierarchical microstructure.

4. A method of preparing a mold for forming a hierarchical microstructure, comprising:
forming a polymer membrane on a substrate;
aligning a nanopatterned first mold on the polymer membrane, followed by heating and compressing at a first temperature and a first pressure and then cooling, so that nanopatterns corresponding to the nanopatterns of the first mold are formed on the polymer membrane; and
aligning a micropatterned second mold on the nanopatterned polymer membrane, followed by heating and compressing at a second temperature and a second pressure and then cooling, so that micropatterns corresponding to the micropatterns of the second mold are formed on the nanopatterned polymer membrane,
wherein the second pressure is higher than the first pressure and the second temperature is lower than the first temperature.

5. The mold-preparing method according to claim 4, wherein the first pressure is 3 MPa or less and the second pressure is 5 MPa or less in that the second pressure is higher than the first pressure, and a time for applying the second pressure is longer than that of the first pressure by twice or more.

6. The mold-preparing method according to claim 4, wherein the first temperature ranges from Tg−30° C. to Tg+20° C., and the second temperature ranges from Tg−70° C. to Tg−40° C.

7. The mold-preparing method according to claim 4, wherein the micropatterned part of the polymer membrane, which is heated and compressed by the second mold at the second temperature and the second pressure, is partially restored in its shape by the resilience of the polymer membrane.

8. The mold-preparing method according to claim 4, which further comprises:
applying a curable pre-polymer composition on a nano- or micro-patterned silicon mater;
curing the applied curable pre-polymer composition; and
detaching the cured polymer from the silicon mater.

9. The mold-preparing method according to claim 4, wherein the first mold and the second mold are subject to pre-treatment in their surface by a reactive ion etching process to facilitate the detachment of them from the polymer.

10. A method of preparing a hierarchical microstructure, comprising:
applying a photocurable pre-polymer composition on the mold prepared from the method according to claim 4;
curing the applied photocurable pre-polymer composition; and
detaching the cured polymer product from the mold.

11. The hierarchical microstructure-preparing method according to claim 10, wherein the photocurable pre-polymer composition comprises at least one polymer selected from the group consisting of polymethyl methacrylate (PMMA) or polyurethane (PUA).

12. The hierarchical microstructure-preparing method according to claim 10, wherein the photocurable pre-polymer composition is cured by displacing a polymer film or a substrate as a support, so that the polymer film or the substrate is provided as a backbone.

13. A hierarchical microstructure prepared by the method according to claim 10.

14. A multiscale patterned polymer membrane prepared by using the hierarchical microstructure according to claim 13 as a pattern-forming mold.

15. A fuel cell comprising the multiscale patterned polymer membrane according to claim 14 as a membrane electrode assembly (MEA).

16. The mold-preparing method according to claim 4, which further comprises thinly coating a polymer having a low creep behavior to produce a sacrificial layer for reserving the original shape of the nanopatterns after forming the nanopatterns using the first mold, and removing the sacrificial layer using a solvent after forming the micropatterns using the second mold.

17. The mold-preparing method according to claim 16, wherein the polymer is polymethyl methacrylate (PMMA) or polystyrene (PS), and the solvent is a nonpolar solvent.

18. The mold-preparing method according to claim 16, wherein the nonpolar solvent is toluene.

19. A mold for forming the hierarchical microstructure according to claim 2, having engraved patterns corresponding to 3-dimensional fine patterns including the nanopatterns and micropatterns formed in the hierarchical microstructure.

20. A method of preparing a hierarchical microstructure, comprising:
applying a photocurable pre-polymer composition on the mold prepared from the method according to claim 5;
curing the applied photocurable pre-polymer composition; and
detaching the cured polymer product from the mold.
